(19) United States
(12) Patent Application Publication
(10) Pub. No.: US 2025/0177791 A1
(43) Pub. Date: Jun. 5, 2025

(54) AUTOMATIC DISCHARGE SYSTEM ABSORBING THE EFFECT OF HALOGENIC ACID

(71) Applicant: NERO ENDÜSTRI SAVUNMA SANAYI ANONIM SIRKETI, Ankara (TR)

(72) Inventor: ALICAN ÖKÇÜN, Ankara (TR)

(73) Assignee: NERO ENDÜSTRI SAVUNMA SANAYI ANONIM SIRKETI, Ankara (TR)

(21) Appl. No.: 18/713,200

(22) PCT Filed: Aug. 9, 2023
(86) PCT No.: PCT/TR2023/050792

§ 371 Date: May 24, 2024

(30) Foreign Application Priority Data
Aug. 16, 2022 (TR) 2022/012922

(51) Int. Cl. A62C 35/02

(52) U.S. Cl. CPC A62C 35/02

(57) ABSTRACT

The present invention relates to an automatic discharge system that absorbs the halogenic acid effect in case of fire. The main aim of the present invention is to develop a new system that provides suppression of fire and/or attacks without harming people and the environment. The system of the present invention comprises a decontamination system integrated with fire extinguishing and explosion suppression systems and CBRN detection and filtration systems, it neutralizes and absorbs both the halogen effect that occurs in explosion suppression systems and the chemical warfare agents released in CBRN attacks, as well as the petrochemicals ketone group, chlorinated organics, corrosive chemicals, alcohols and acids, which are phosphorus, sulfur and nitrogen compounds.

### FIELD OF THE INVENTION

The present invention relates to an automatic discharge system that absorbs the halogenic acid effect in case of fire.

### STATE OF THE ART

In case of fire in vehicles or buildings in the current situation, fire explosion suppression systems are currently utilized. The extinguishing agents in said systems are sent to the fire area and in tis way it is aimed to extinguish the fire. Typically, these types of systems operate efficiently in fully closed environments. However, poisoning is inevitable due to the insufficient concentration level in places that cannot be fully closed. If the sufficient concentration level cannot be reached in said extinguishing process, heptafluorocarbon cannot extinguish the fire and HFC 227 gas starts to burn. The flora atom in the heptafluorocarbon emerges and harms living things and the environment at this level of combustion (because the fire cannot be resolved quickly). This process happens very quickly. For this reason, it is aimed to neutralize halogenic acids at the time of formation by adding additives (gas or liquid type decontamination agents) into fire extinguishing agents in the related technical field. It is desired to prevent possible gas escape by pressing materials such as dust decontamination or other basic-acidic decontamination liquids and explosion suppression systems used in the world into high pressure tubes and combining them with (NaHCO₃) sodium bicarbonate.

Currently, there are also salts containing halogenic acids in fire extinguisher explosion suppression tubes. The gases in the fire extinguisher tubes are primarily CO₂, N₂ and H₂O vapor, and if the anion group in the oxidant is nitrate, they contain traces of ammonia, NOₓ and CO. The anion group contains halogen acid. If the reducing agents are cyanoguanidines, dicyandiamide or nitroguanidine, CO₂, H₂O vapor, ammonia, NOₓ or even traces of hydrogen cyanide may be present.

Reductants such as metal powders will oxidize and become solid phase in the aerosol. These halogenic radicals, which occur in explosion suppression systems, are harmful to the human lungs and the environment if inhaled. The disposal of these halogenic acids presents a major problem.

Furthermore, decontamination is needed to neutralize chemical agents and toxic industrial chemicals released into the environment in CBRN attacks. There is no decotamination system among the existing systems which is integrated with fire extinguishing and explosion suppression systems and CBRN systems that will act quickly. Commercial products in the current market are not integrated into explosion suppression or CBRN systems, but are delivered manually as an external tube. Since it is manual and there are delays in the delivery of the fast-act chemical to the environment, the inhalation of the chemical that spreads into the environment harms living things.

The documents determined in the patent and literature research carried out for the state of the art are summarized below.

The Chinese utility model application with publication number CN213912050 U relates to a fire extinguishing and carbon dioxide explosion suppression device. Said device comprises a container for storing extinguishing agent, a second vessel for storing pressurized inert gas, and a spray element for spraying pressurized extinguishing agent. However, there is no explanation in the document about the tube, transmission line and automatic discharge unit where the halogenic acid absorbing chemical is stored specifically.

Korean patent application with publication number KR1020160069657 A relates to the automatic fire extinguishing room that ensures the safety of the experimenters by discharging gases such as harmful gas, odor, etc. formed during the chemical experiment. However, there is no explanation in the document about the tube, transmission line and automatic discharge unit where the halogenic acid absorbing chemical is stored specifically.

As a result due to the abovementioned disadvantages and the insufficiency of the current solutions regarding the subject matter, a development is required to be made in the relevant technical field.

### BRIEF DESCRIPTION OF THE INVENTION

The present invention relates to an automatic discharge system that absorbs the halogenic acid effect which fulfils the abovementioned requirements, eliminates all disadvantages and brings some additional advantages.

The present invention aims to solve the abovementioned disadvantages by being inspired from the current conditions.

The main aim of the present invention is to develop a new system that provides suppression of fire and/or attacks without harming people and the environment. The system of the present invention comprises a decontamination system integrated with fire extinguishing and explosion suppression systems and CBRN detection and filtration systems, it neutralizes and absorbs both the halogen effect that occurs in explosion suppression systems and the chemical warfare agents released in CBRN attacks, as well as the petrochemicals ketone group, chlorinated organics, corrosive chemicals, alcohols and acids, which are phosphorus, sulfur and nitrogen compounds. In order to eliminate the aforementioned CBRN attacks and threats arising in explosion suppression systems, a decontamination formed by mixing metal oxide or sodium bicarbonate is included in the system of the invention. The invention uses the feature of a system that will activate the decontamination system as a result of both the material properties mentioned and the information the system receives from the sensors.

The distinctive feature of the invention in the presence of the state of the art; it is provided that the chemical mixture, which absorbs the halogenic acid effect is not manually given but integrated into an explosion suppression and/or CBRN systems and that the need is solved with the automatic system main valve without the need for manual damping.

The invention can be used on civil and industrial platforms (land, sea, etc.) where fire extinguishing and explosion suppression systems are used, as well as on all industrial platforms where CBRN (chemical, biological, radiological and nuclear) detection and filtration systems are used. It can be used during and after a fire, including all social areas, and in CBRN attacks.

Chemicals that are not harmful to living things are used in the system that is the subject of the present invention. The rate of use of metal oxide material in chemicals is determined according to the level standards that are harmful to health. There is no chemical limitation for decontamination in non-living places. For this reason, metal oxide values are used above the permissible health levels.

The inventive system detects CBRN if there is no fire in the environment, and activates high-pressure cylinders based on the information it receives from the sensors manually or automatically. These tubes start the system by spraying very fast pulverized powder/liquid/gas in rooms or open areas in certain areas (preferably up to about 3 meters). In case there is a chemical attack in the environment, according to the threat information coming from the CBRN detection system and/or explosion suppression systems, the valve on the tube is opened and it is possible to automatically absorb the halogenic acid effect by giving the metaloxide and/or sodium bicarbonate mixture to the environment where the threat is present.

The structural and characteristic features of the present invention will be understood clearly by the following drawings and the detailed description made with reference to these drawings and therefore the evaluation shall be made by taking these figures and the detailed description into consideration.

### FIGURES CLARIFYING THE INVENTION

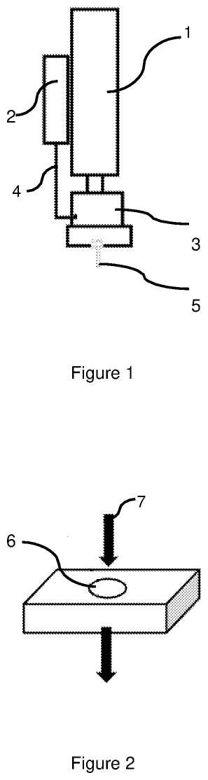

In FIG. 1, a general view of the inventive system is given.

In FIG. 2, the general view of the automatic discharge unit is given.

### DESCRIPTION OF THE PART REFERENCES

1 Tube
2 Halogenic acid effect absorber chemical tube
3 Automatic discharge unit
4 Transmission line
5 Vacuum venturi
6 Aluminum disc
7 Decontamination powder passage direction under vacuum

### DETAILED DESCRIPTION OF THE INVENTION

In this detailed description, the preferred embodiments of the present invention are described by means of examples only for clarifying the subject matter.

The present invention relates to an automatic discharge system that absorbs the halogenic acid effect in case of fire. Said system comprises at least one tube (1) containing chemicals for fire extinguishing. The inventive system comprises at least one halogenic acid effect absorber chemical tube (2) in addition to said tube (1). The chemicals in the halogenic acid effect absorber chemical tube (2) show effect by combining with the chemicals in the tube (1). The amount of use of the chemicals mentioned in the invention is not distinctive, it is important for the invention to combine the chemicals in the halogenic acid effect absorber chemical tube (2) with the chemicals in the tube (1). The combination of chemicals in the tube (1) and the halogenic acid effect absorber chemical tube (2) takes place in the automatic discharge unit (3).

At least one aluminum disc (6) and at least one vacuum venturi (5) are used to discharge the discharged gas in the automatic discharge unit (3). The aluminum disc (6) opens the automatic discharge unit (3), allowing the gas to be discharged. The vacuum venturi (5) acts as a distributor.

It is also possible to use steel material as an alternative to the aluminum disc (6) within the scope of the present invention. However, during blasting, the aluminum disc (6) will explode in a shorter time and inject the gas into the environment. Unlike aluminum, steel material can also be used in theory. However, since the resistance of steel is higher than aluminum, it will explode and therefore the reaction time of the system will be late.

A transmission line (4) is configured between the halogenic acid effect absorber chemical tube (2) and the automatic discharge unit (3) so that the contents of the halogenic acid effect absorber chemical tube (2) are combined with the tube (1) content. Said transmission line (4) carries the contents of the halogenic acid effect absorber chemical tube (2).

The gas discharged in the automatic discharge unit (3) is discharged with high pressure through the aluminum disc (6) and at least one vacuum venturi (5).

If powder deconyamination material is placed inside the tube (1), this material also inactivates HFC227 and breaks down Titanium dioxide. Therefore, it is placed at the end of the system in a vacuum environment so as to use it.

When the main valve of the tube (1) containing HFC (control valve of the tube (1)) is opened, the flow pressure created there attracts dust decontamination inside the tube (1), and dust decontamination begins to be removed with the nozzle effect (with the effect of vacuum) via vacuum, the halogenic acid effect absorber chemical tube (2) is placed in front of the outlet, and dust decontamination can be scattered around when it is disintegrated with the outlet. In this way, the harm to human health caused by the halogenic acid effect created by HFC 227 ea as a result of the late extinguishing of the fires is minimized with this method.

In the invention, the tube (1) and the halogenic acid effect absorber chemical tube (2) explode at the same time.

1. An automatic discharge system that absorbs the halogenic acid effect in case of fire, characterized in that, it comprises the following;
at least one tube (1) containing chemicals for fire extinguishing,
halogenic acid effect absorber chemical tube (2) show effect by combining with the chemicals in the tube (1),
automatic discharge unit (3), in order to ensure that the chemicals in the tube (1) and the hallogenic acid effact absorber chemical tube (2) are combined and the gas is discharged,
a transmission line (4) positioned between the halogenic acid effect absorber chemical tube (2) and the automatic discharge unit (3) so that the contents of the halogenic acid effect absorber chemical tube (2) are combined with the tube (1) content,
aluminum disc (6) that opens the automatic discharge unit (3), allowing the gas to be discharged,
at least one vacuum venturi (5) to act as a distributor in the automatic discharge unit (3).
